(19) United States
(12) Patent Application Publication
(10) Pub. No.: US 2008/0199686 A1
(43) Pub. Date: Aug. 21, 2008

(54) SINTERED MAGNESIUM OXIDE, AND PLASMA DISPLAY PANEL PREPARED THEREFORM

(75) Inventors: Hee-Young Chu, Yongin-si (KR); Min-Suk Lee, Yongin-si (KR); Soon-Sung Suh, Yongin-si (KR); Young-su Kim, Yongin-si (KR); Deok-Hyun Kim, Yongin-si (KR); Suk-ki Kim, Yongin-si (KR); Jong-Seo Choi, Yongin-si (KR); Jae-Hyuk Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 12/023,208

(22) Filed: Jan. 31, 2008

(30) Foreign Application Priority Data
Feb. 21, 2007 (KR) 200717558

(51) Int. Cl. B32B 5/16

(52) U.S. Cl. 428/330; 428/402

(57) ABSTRACT

A sintered magnesium oxide has a density of 3.5 g/cm³ or more, and has a grain size that is more than or equal to thirty times the average particle diameter of magnesium oxide particles. An MgO protective layer made from the sintered magnesium oxide reduces a discharge voltage of a plasma display panel, improves response speed, and provides a high-purity film quality.

### CROSS-REFERENCE TO RELATED APPLICATION

This application claims the benefit of Korean Application No. 2007-17558 filed Feb. 21, 2007, in the Korean Intellectual Property Office, the disclosure of which is incorporated herein by reference.

### BACKGROUND OF THE INVENTION

1. Field of the Invention

Aspects of the present invention relate to a sintered magnesium oxide, a method of preparing the same, and a plasma display panel made using the same. More particularly, aspects of the present invention relate to a sintered magnesium oxide for forming an MgO protective layer that reduces a discharge voltage of a plasma display panel, improves a response speed, and provides high-purity film quality.

2. Description of the Related Art

A plasma display panel (PDP) is a display device that forms an image by exciting a phosphor with vacuum ultraviolet (VUV) rays generated by gas discharge in discharge cells. PDPs are broadly classified into alternating current (AC) types and direct current (DC) types. AC PDPs are the most widely used. The AC PDP has a basic structure where two electrodes are arranged to cross and face each other between two substrates filled with a discharge gas and partitioned by barrier ribs. One electrode is coated with a dielectric layer for generating wall charges, and the other electrode is disposed opposite thereto and coated with a phosphor layer.

A protective layer that is generally composed of MgO is disposed on the dielectric layer. The protective layer has sputtering resistance to prevent damage due to ion bombardment of the discharge gas while the plasma display panel is discharged. The protective layer is covered on the dielectric layer in the form of a transparent protective thin film having a thickness of 3000 to 7000 Å, which protects the dielectric layer from the ion bombardment and lowers the discharge voltage through the secondary emission of electrons.

Since the protective layer can have widely various characteristics depending upon the conditions of the depositing process heat and the layer-forming process, it is hard to maintain display quality within a certain level. The protective layer may cause black noise due to an address discharge delay, which is an address miss in which light is not emitted in a selected cell. The black noise generally occurs in a boundary between a light-emitting region and a no light-emitting region, but may occur at other regions. The address miss occurs at low intensity when there is no address discharge or even when a scan discharge has progressed. Accordingly, a lot of research on diminishing the address discharge delay time has been undertaken to prevent the black noise and the address miss.

### SUMMARY OF THE INVENTION

One embodiment of the present invention provides a sintered magnesium oxide for forming an MgO protective layer that can reduce a discharge voltage of a plasma display panel, improve the response speed, and provide a high quality film with high purity. Another embodiment of the present invention provides a method of preparing the sintered magnesium oxide. Yet another embodiment of the present invention provides a plasma display panel made by using the sintered magnesium oxide.

According to one embodiment of the present invention, provided is a sintered magnesium oxide that has a density of 3.5 g/cm³ or more, and an average grain size that is greater than or equal to thirty times the average diameter of the magnesium oxide particles before sintering.

According to an aspect of the present invention, the average grain size of the sintered magnesium oxide may be 35 to 70 times as large as the average diameter of the magnesium oxide particle.

According to an aspect of the present invention, the sintered magnesium oxide may have a density of 3.51 to 3.57 g/cm³.

According to another embodiment of the present invention, a plasma display panel includes: a first substrate and a second substrate facing each other; a plurality of address electrodes disposed on the first substrate; a first dielectric layer disposed on one surface of the first substrate while covering the address electrodes; a plurality of barrier ribs having a predetermined height from the first dielectric layer and disposed in a space between the first substrate and the second substrate to partition the space into discharge cells of a predetermined size; a phosphor layer disposed in the discharge cells; a plurality of display electrodes disposed on one side of the second substrate facing the first substrate in a direction crossing the address electrodes; a second dielectric layer disposed on one surface of the second substrate while covering the display electrodes; and an MgO protective layer disposed to cover the second dielectric layer and formed from the sintered magnesium oxide.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially-exploded perspective view showing a plasma display panel according to one embodiment of the present invention.

FIG. 2 is a representative scanning electron microscope (SEM) photograph of magnesium oxide particles such as were used to prepare the sintered magnesium oxide according to Examples 1 and 2 and Comparative Example 1.

FIG. 3 is a representative scanning electron microscope (SEM) photograph of magnesium oxide particles such as were used to prepare the sintered magnesium oxide according to Example 3.

FIG. 4 is a scanning electron microscope (SEM) photograph of sintered magnesium oxide particles prepared according to Example 1.

FIG. 5 is a scanning electron microscope (SEM) photograph of sintered magnesium oxide particles prepared according to Example 2.

FIG. 6 is a scanning electron microscope (SEM) photograph of sintered magnesium oxide particles prepared according to Example 3.

FIG. 7 is a scanning electron microscope (SEM) photograph of sintered magnesium oxide particles prepared according to Comparative Example 1.

FIG. 8 is a graph showing discharge firing voltages of plasma display panels that are respectively made by using sintered magnesium oxides according to Examples 1 to 3 and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide a sintered magnesium oxide formed from magnesium oxide particles and having a density of more than 3.5 g/cm³ and that has an average grain size that is over 30 times the average diameter of the magnesium oxide particles. According to another aspect of the present invention, the sintered magnesium oxide may have a density ranging from 3.51 to 3.57 g/cm³. According to another aspect of the present invention, the sintered magnesium oxide may have an average grain size 35 to 70 times the average diameter of the magnesium oxide particles.

When an MgO protective layer of a plasma display panel is prepared with a sintered magnesium oxide having a density of more than 3.5 g/cm³ and that has an average grain size that is 30 times the average diameter of magnesium oxide particles, the MgO protective layer can reduce the discharge voltage improve the response speed of the plasma display panel, and provide an excellent high quality membrane with high purity.

When the sintered magnesium oxide has a density of more than 3.5 g/cm³, it may have already undergone grain growth. When the sintered magnesium oxide has a grain size that is more than 30 times as big as the average diameter of the magnesium oxide particles, the magnesium oxide particles are sufficiently sintered and do not remain on the surface of the sintered magnesium oxide with evaporated internal pores, providing an MgO protective layer having stability and excellent discharge characteristics.

The average grain size of the sintered magnesium oxide can be measured by a Heyn method. According to the Heyn method, the average grain size can be measured by drawing a straight line with a predetermined length in an arbitrary direction on a specimen (actually, on a structure photograph enlarged in an appropriate proportion) and counting the number of points where the straight line meets with a grain (a point where a grain crosses a straight line), thereby calculating the average grain size with the number of the crossing points (PL) per unit straight line rather than counting the number of grains per unit area. Determining the PL value makes it possible to calculate the number of grains per unit volume (PV), the number of grains per unit area (PA), the surface area of grains per unit volume (SV), and the like. These values can be calculated by the following formulas when the enlargement proportion of a structure photograph is m.

PL=(the number of crossing points)/(length of a straight line on a photograph/m)

PV=6/3×PL

PA=0.422×PL³

SV=0.735×PL³

The magnesium oxide particles may include either primary magnesium oxide particles or secondary magnesium oxide particles. The primary magnesium oxide particles become adhered to one another to form a secondary particle. The primary or secondary magnesium oxide particles can be used regardless of size.

A method of preparing a sintered magnesium oxide by using the magnesium oxide particles has no particular limit, and may include a common sintering method. In particular, a magnesium oxide particle powder is mixed and dried, and then compressed and shaped, and thereafter sintered at a high temperature. The sintering method may have different conditions depending on the kind of magnesium oxide particles, their size, and the like, which is generally well-known in this field and can be omitted without more detailed description. Generally, a longer sintering time at a given temperature provides a greater density and a greater average grain size.

According to another embodiment of the present invention, provided is a plasma display panel that includes: a first substrate and a second substrate facing each other; a plurality of address electrodes disposed on the first substrate; a first dielectric layer disposed on one surface of the first substrate while covering the address electrodes; a plurality of barrier ribs having a predetermined height from the first dielectric layer and disposed in a space between the first substrate and the second substrate to partition the space into discharge cells of a predetermined size; a phosphor layer disposed in the discharge cells; a plurality of display electrodes disposed on one side of the second substrate facing the first substrate in a direction crossing the address electrodes; a second dielectric layer disposed on one surface of the second substrate while covering the display electrodes; and an MgO protective layer disposed to cover the second dielectric layer and formed from the sintered magnesium oxide.

An embodiment of the present invention will hereinafter be described in detail with reference to the accompanying drawings. However, aspects of the present invention can be realized in various different ways, and is not limited to the illustrated embodiments.

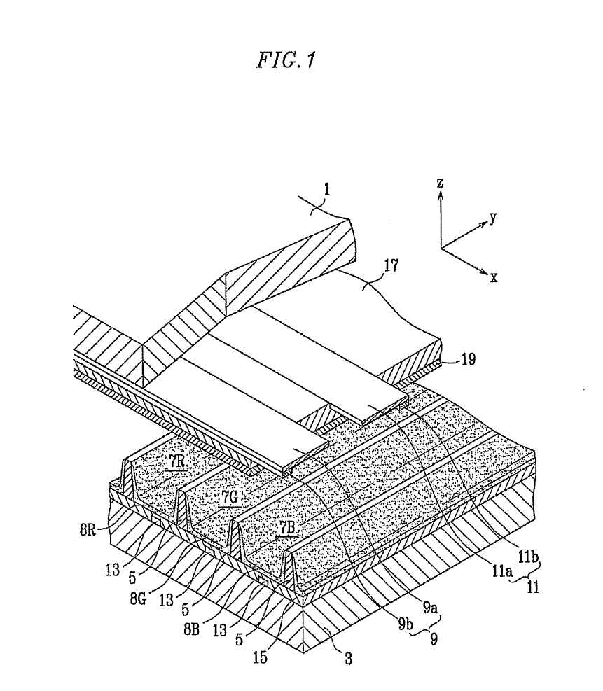

FIG. 1 is a partially-exploded perspective view showing the structure of a plasma display panel according to one embodiment. Referring to the drawing, the PDP includes a first substrate 3, a plurality of address electrodes 13 disposed in one direction (a Y direction in the drawing) on the first substrate 3, and a dielectric layer 15 disposed on the surface of the first substrate 3 covering the address electrodes 13. Barrier ribs 5 are formed on the dielectric layer 15, and red (R), green (G), and blue (B) phosphor layers 8R, 8G, and 8B are disposed in discharge cells 7R, 7G, and 7B formed between the barrier ribs 5.

The barrier ribs 5 may be formed in any shape, as long as their shape can partition the discharge space. In addition, the barrier ribs 5 can have diverse patterns. For example, the barrier ribs 5 may be formed as an open type pattern such as stripes or as a closed type pattern such as a waffle, a matrix, or a delta shape. Also, the closed-type barrier ribs may be formed such that a horizontal cross-section of the discharge space is a polygon such as a quadrangle, a triangle, or a pentagon, or a circle or an oval.

Display electrodes 9, 11, each including a pair of transparent electrodes 9a and 11a and bus electrodes 9b and 11b, are disposed in a direction crossing the address electrodes 13 (an X direction in the drawing) on one surface of a second substrate 1 facing the first substrate 3. Also, a dielectric layer 17 and a protective layer 19 are disposed on the surface of the second substrate 1 while covering the display electrodes. The protective layer 16 comprises the MgO protective layer 16 according to an aspect of the invention.

The MgO protective layer 19 comprises a sintered magnesium oxide according to aspects of the present invention. The MgO protective layer 19 may be prepared by a thick-layer printing method or a plasma deposition method. The deposition method may be relatively strong against sputtering by ion impact, and can reduce a sustain voltage and a discharge firing voltage by secondary electron emission.

The plasma deposition method may include magnetron sputtering, electron beam deposition, ion beam assisted deposition (IBAD), chemical vapor deposition (CVD), or ion plating forming a membrane by ionizing evaporated ions. The ion plating method has similar characteristics regarding close contacting properties and crystallinity of an MgO protective layer to the sputtering method, but can deposit an MgO protective layer at a high speed of 8 nm/s.

Discharge cells are formed at positions where the address electrodes 13 of the first substrate 3 are crossed by the display electrodes 9,11 of the second substrate 1.

The first substrate 3 and the second substrate 1 are sealed under vacuum at their overlapped edges by a sealing glass (not shown).

In the plasma display panel, address discharge is performed by applying an address voltage (Va) to a space between the address electrodes 13 and the display electrodes 9, 11. When a sustain voltage (Vs) is applied to a space between a pair of display electrodes 9 and 11, an excitation source generated from the sustain discharge excites a corresponding phosphor layer 8B, 8G or 8R to thereby emit visible light through the second substrate 1 and display an image. The phosphors 8B, 8G or 8R are generally excited by vacuum ultraviolet (VUV) rays.

The following examples illustrate aspects of the present invention in more detail. However, it is understood that the present invention is not limited by these examples.

Preparation of a Sintered Magnesium Oxide

### EXAMPLE 1

A sintered magnesium oxide was prepared by sintering a secondary magnesium oxide having an average particle diameter of 1 μm, at 1670° C. for 16 hours. The density of the sintered magnesium oxide was 3.51 g/cm³.

### EXAMPLE 2

A sintered magnesium oxide was prepared by sintering a secondary magnesium oxide having an average particle diameter of 1 μm, at 1670° C. for 30 hours. The density of the sintered magnesium oxide was 3.51 g/cm³.

### EXAMPLE 3

A sintered magnesium oxide was prepared by sintering a primary magnesium oxide having an average particle diameter of 120 nm, at 1670° C. for 16 hours. The density of the sintered magnesium oxide was 3.525 g/cm³.

### COMPARATIVE EXAMPLE 1

A sintered magnesium oxide was prepared by sintering a secondary magnesium oxide having an average particle diameter of 1 μm, at 1670° C. for 11 hours. The density of the sintered magnesium oxide was 3.5 g/cm³.

Measurement of the Grain Size of the Prepared Sintered Oxides

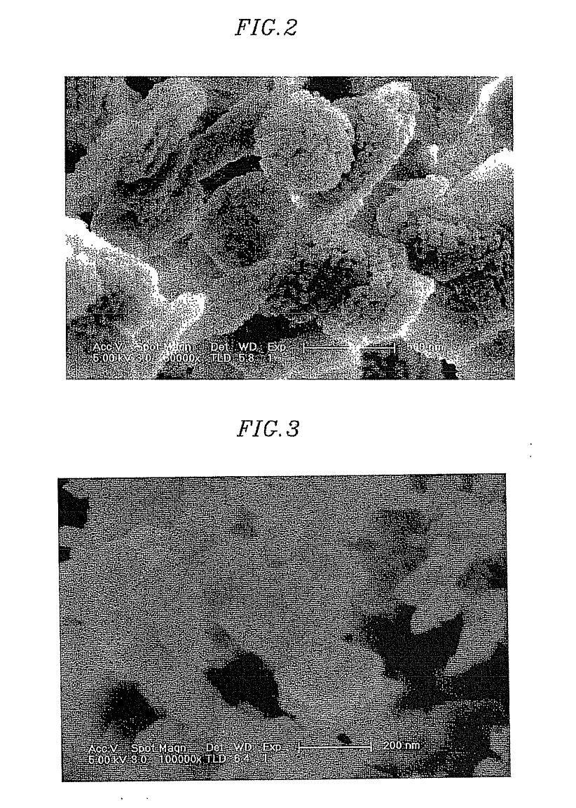

The magnesium oxide particles used as starting material in Examples 1 to 3 and Comparative Example 1 were examined with a scanning electron microscope (SEM). A representative SEM photograph of the magnesium oxide particles used in Examples 1 and 2 and Comparative Example 1 is provided in FIG. 2, and a representative SEM photograph of the magnesium oxide particles used in Example 3 is provided in FIG. 3.

Referring to FIG. 2, the magnesium oxide particles used in Examples 1 and 2 and Comparative Example 1 were secondary magnesium oxide particles having an average diameter of 1 μm. Referring to FIG. 3, the magnesium oxide particles used in Example 3 were primary magnesium oxide particles having an average diameter of 120 nm.

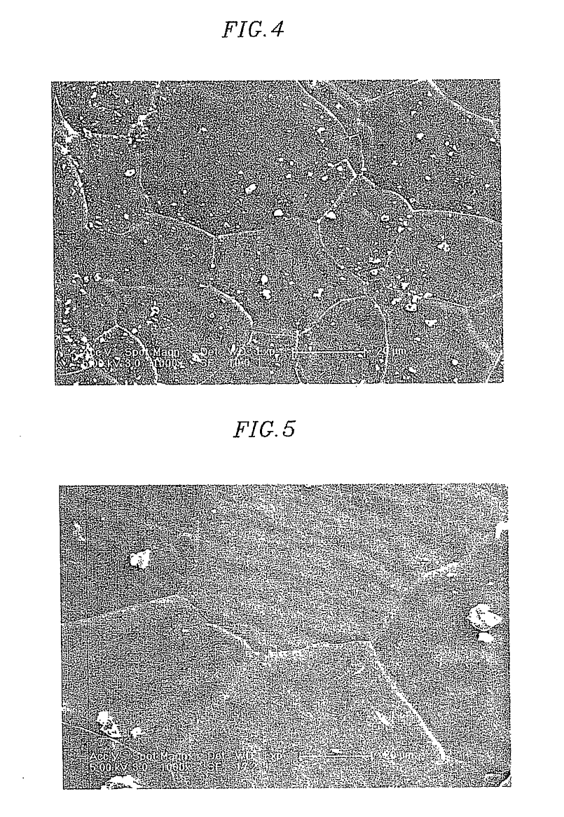

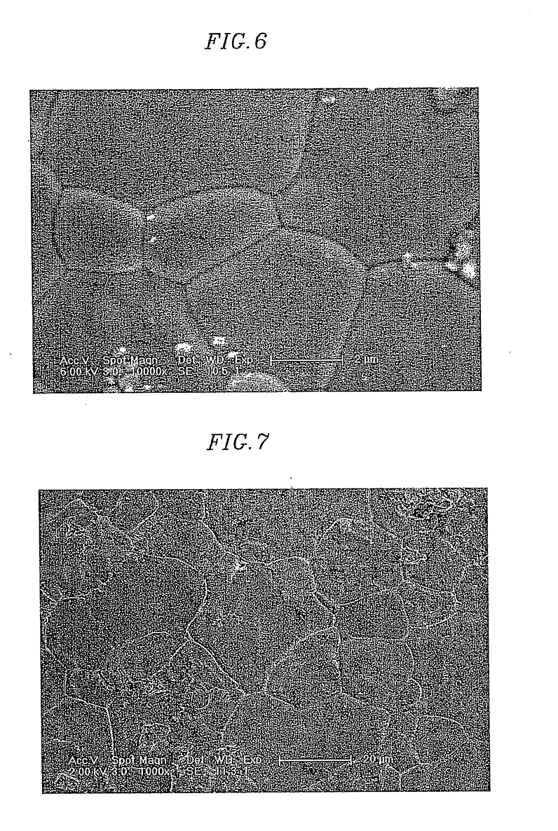

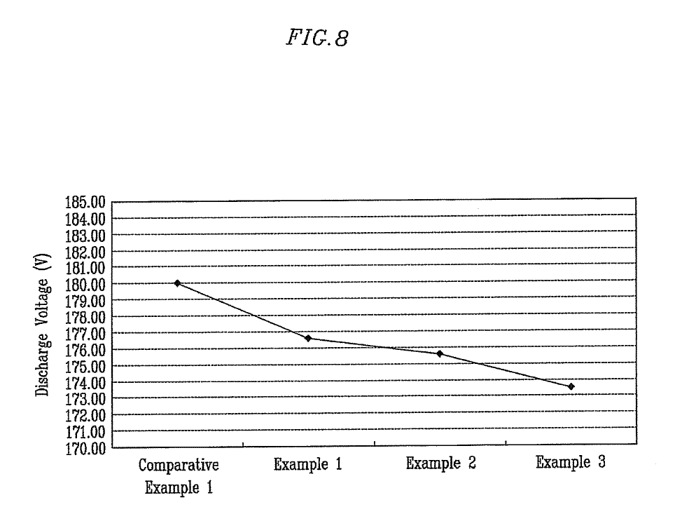

In addition, the sintered magnesium oxides produced according to Examples 1 to 3 and Comparative Example 1 were examined with a scanning electron microscope. The results are respectively provided in FIGS. 4 to 7. The sintered magnesium oxides were measured to determine grain sizes by using their SEM photographs.

The sintered magnesium oxide of Examples 1 and 2 had an average grain size of 36.5 μm, the sintered magnesium oxide of Example 3 had an average grain size of 65 μm, and the sintered magnesium oxide of Comparative Example 1 had an average grain size of 24.5 μm.

Accordingly, the average grain size of the sintered magnesium oxide of Example 1 was 36.5 times the average diameter of the magnesium oxide particles used to produce the sintered magnesium oxide of Example 1. The average grain size of the sintered magnesium oxide of Example 2 was 65 times the average diameter of the magnesium oxide particles used to produce the sintered magnesium oxide of Example 2. The average grain size of the sintered magnesium oxide of Example 3 was 66.6 times the average diameter of magnesium oxide particles used to produce the sintered magnesium oxide of Example 3. On the other hand, the sintered magnesium oxide of Comparative Example 1 was only 24.5 times the average diameter of magnesium oxide particles used to produce the sintered magnesium oxide of Comparative Example 1.

Fabrication of a Plasma Display Panel (PDP)

A display electrode made of an indium tin oxide conductor material was formed on an upper substrate made of soda lime glass by a common method to have a stripe shape.

Subsequently, a dielectric layer was formed by coating a lead-based glass paste over the entire surface of the upper substrate on which the display electrode was formed, and then sintering the dielectric layer.

On the dielectric layer, an MgO protective layer was deposited by an ion plating method by using a sintered magnesium oxide, preparing an upper panel.

A series of upper panels were formed, each containing one of the sintered magnesium oxides according to Examples 1 to 3 and Comparative Example 1, and the upper panels were used to form plasma display panels (PDPs).

Evaluation of Discharge Characteristics of the Prepared Plasma Display Panel (PDP)

The prepared plasma display panels (PDPs) were measured regarding discharge firing voltage. The results are provided in FIG. 8. Referring to FIG. 8, the plasma display panels (PDP) including sintered magnesium oxides of Examples 1 to 3 were found to have lower discharge firing voltages than the plasma display panel including a sintered magnesium oxide of Comparative Example 1. Therefore, an MgO protective layer made from the sintered magnesium oxide according to aspects of the present invention can reduce the discharge voltage of a plasma display panel, improve response speed, and provide a high-purity film quality.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A sintered magnesium oxide prepared from magnesium oxide particles, the sintered magnesium oxide having a density of more than 3.5 g/cm³ and an average grain size that is at least 30 times an average diameter of the magnesium oxide particles.

2. The sintered magnesium oxide of claim 1, wherein the sintered magnesium oxide has an average grain size that is 35 to 70 times the average diameter of the magnesium oxide particles.

3. The sintered magnesium oxide of claim 1, wherein the sintered magnesium oxide has a density ranging 3.51 to 3.57 g/cm³.

4. The sintered magnesium oxide of claim 1, wherein the magnesium oxide particles are selected from the group consisting of primary magnesium oxide particles, secondary particles, and a combination thereof.

5. A plasma display panel comprising:
a first substrate and a second substrate facing the first substrate;
a plurality of address electrodes disposed on the first substrate;
a first dielectric layer disposed on a surface of the first substrate and covering the address electrodes;
a plurality of barrier ribs having a predetermined height from the first dielectric layer and disposed in a space between the first substrate and the second substrate to partition the space into discharge spaces, each having a predetermined size;
a phosphor layer disposed in each of the discharge spaces;
a plurality of display electrodes disposed on one side of the second substrate facing the first substrate in a direction crossing the address electrodes;
a second dielectric layer disposed on a surface of the second substrate and covering the display electrodes; and
an MgO protective layer disposed to cover the second dielectric layer and formed from a sintered magnesium oxide that is prepared from magnesium oxide particles, the sintered magnesium oxide having a density of more than 3.5 g/cm³ and an average grain size that is at least 30 times as an average diameter of the magnesium oxide particles.

6. The plasma display panel of claim 5, wherein the sintered magnesium oxide has an average grain size that is 35 to 70 times the average diameter of the magnesium oxide particles.

7. The plasma display panel of claim 5, wherein the sintered magnesium oxide has a density ranging from 3.51 to 3.57 g/cm³.

8. The plasma display panel of claim 5, wherein the magnesium oxide particles are selected from the group consisting of primary magnesium oxide particles, secondary particles, and a combination thereof.

9. A plasma display panel comprising:
electrodes disposed on a substrate;
a dielectric layer covering the electrodes; and
an MgO protective layer covering the dielectric layer,
wherein the MgO protective layer is formed from a sintered magnesium oxide that is prepared from magnesium oxide particles, the sintered magnesium oxide having a density of more than 3.5 g/cm³ and an average grain size that is at least 30 times an average diameter of the magnesium oxide particles.

10. The plasma display panel of claim 9, wherein the sintered magnesium oxide has an average grain size that is 35 to 70 times the average diameter of the magnesium oxide particles.

11. The plasma display panel of claim 9, wherein the sintered magnesium oxide has a density ranging from 3.51 to 3.57 g/cm³.

12. The plasma display panel of claim 9, wherein the magnesium oxide particles are selected from the group consisting of primary magnesium oxide particles, secondary particles, and a combination thereof.
